(19) United States
(12) Patent Application Publication
(10) Pub. No.: US 2007/0010361 A1
(43) Pub. Date: Jan. 11, 2007

(54) Belt tensioning device with external damping sleeve

(76) Inventors: Vladimir Kobelev, Attendorn (DE); Manfred Jung, Westerburg (DE); Rudolf Berger, Simmerath (DE)

Correspondence Address: Wyatt, Gerber & O'Rourke, LLP, 99 Park Avenue, New York, NY, 10016, US

(21) Appl. No.: 11/474,597

(22) Filed: Jun. 26, 2006

(30) Foreign Application Priority Data
Jun. 24, 2005 (DE) 102005029789.7-12

(51) Int. Cl. F16H 7/14; F16H 7/22

(52) U.S. Cl. 474/115; 474/101; 474/113

(57) ABSTRACT

A belt tensioning device has a torsion spring assembly and a damping assembly with a housing with a longitudinal axis A. A torsion spring is positioned in the housing so as to extend coaxially relative to the longitudinal axis A and which, by means of one of its ends, is secured in the housing in a rotationally fixed way. A tensioning arm is supported relative to the housing so as to be oscillatingly rotatable around the longitudinal axis A and is connected to the other end of the torsion spring in a rotationally fixed way. A tensioning roller is supported at a free end of the tensioning arm so as to be rotatable around an axis of rotation B and extending parallel relative to the longitudinal axis A. The damping assembly surrounds the housing coaxially relative to the longitudinal axis A and comprises cylindrical friction face pairs.

### FIELD OF THE INVENTION

The invention relates to a belt tensioning device having a torsion spring assembly and a damping assembly with a housing with a longitudinal axis. A torsion spring is positioned in the housing so as to extend coaxially relative to the longitudinal axis and which, by means of one of its ends, is secured in the housing in a rotationally fixed way. A tensioning arm is supported relative to the housing so as to be oscillatingly rotatable around the longitudinal axis and which is connected to the other end of the torsion spring in a rotationally fixed way. A tensioning roller which, at a free end of the tensioning arm, is supported so as to be rotatable around an axis of rotation extending parallel relative to the longitudinal axis. Such belt tensioning devices are used together with belt drives which comprise at least two belt pulleys and a continuous belt running over same. One of the belt pulleys is a driving pulley wherein the tensioning roller of the belt tensioning device acts on the slack side of the continuous belt to compensate for changes in length of the belt, to avoid oscillations and to ensure that the belt does not jump off the pulleys. The belts can be the now commonly used cogged belts or V-belts. When replacing the belt pulleys and the tensioning roller by chain wheels, the device can, analogously, also be used for chain drives.

A typical application of belt drives is in the drive of auxiliary units of internal combustion engines, wherein a first belt pulley is positioned on the crankshaft and serves as a driving pulley. Further belt pulleys are positioned on the shafts of auxiliary units such as a water pump, generator, air conditioning plant, compressor, etc. and are driven by the belt drive. In such applications, there occurs a belt slack in the direction of rotation behind the driving belt pulley, which slack has to be compensated for by the tensioning roller so that the belt does not jump off the belt pulleys. In operation and under the influence of temperature, the belt length changes, so that the tensioning arm with the tensioning roller has to act on the belt slack under spring pretension. To ensure that the movements of the tensioning arm and of the belt do not change into oscillating movements, there is provided a damping device for such movements of the tensioning arm. The axis of rotation and oscillation of the tensioning arm extends parallel to the axes of rotation of the belt pulley and of the tensioning roller.

### BACKGROUND OF THE INVENTION

European Patent Document EP 1 437 528 A2 discloses a device of the above-mentioned type wherein a damping assembly is arranged between a sleeve connected to the tensioning arm and the inside of the housing tube and cooperates therewith. The effective diameter of the damping assembly is delimited by the housing diameter which has to be kept as small as possible. This results in a disadvantageously long damping assembly.

European Patent Document EP 1 420 192 A2 proposes belt tensioning devices of the above-mentioned type wherein, for damping purposes, the torsion spring is connected by an inner rubber-elastic rotational thrust spring with respect to the housing. In addition, there is provided a radial friction disc which, by means of a pretensioned undulated disc, acts on radial friction faces. Such damping assemblies, overall, are very complicated, and fitting the rotational thrust spring is difficult.

### OBJECT OF THE INVENTION

It is therefore the object of the present invention to provide a belt tensioning device of the above-mentioned type whose damping assembly is greatly simplified.

The objective is achieved by providing a belt tensioning device of this type wherein the damping assembly surrounds the housing coaxially relative to the longitudinal axis and comprises cylindrical friction face pairs subjected to radial loads. The inventive damping device comprises few simply designed parts and is particularly easy to mount. The functionally accurate mounting procedure is easy to monitor because the most important functional parts can be seen from the outside.

### SUMMARY OF THE INVENTION

According to a first preferred embodiment, the damping assembly comprises a circumferentially slotted friction sleeve which, by means of an inner cylindrical face, is positioned on an outer cylindrical face of the housing and which slides on the cylindrical face in the case of a relative movement of the tensioning arm relative to the housing. The cylindrical face can be the original outer face of the housing which can be provided in the form of a drawn tube, so that the cylindrical face does not require any special machining operations. The damping sleeve consisting of suitable plastics constitutes a simple and cheap component.

Furthermore, it is proposed that the friction sleeve is form-fittingly and positively held by means of an outer formed projection. A rib in a bearing eye of the tensioning arm and the friction sleeve is surrounded by a slotted spring sleeve with radial pretension. The outer formed projection of the friction sleeve passes through the slot of the spring sleeve. No additional fixing means are required for fixing the friction sleeve and the spring sleeve relative to the tensioning arm. The rate of damping can easily be varied by replacing a spring sleeve, depending on the type of application. Spring sleeves and C-shaped flat springs are cheap to produce.

The friction sleeve and the spring sleeve can form-fittingly and positively engage one another in the circumferential direction, so that a relative rotational movement between the two parts is not possible. For example, a radial pin or knob at the friction sleeve can engage a bore or a hole in the spring sleeve.

Whereas the bearing eye can surround the housing with a space therebetween, it is possible for the tensioning arm to be supported directly via a plug which is inserted into the bearing eye and which is rotatably supported in the housing, optionally by using an additional friction bearing bush.

According to a further advantageous embodiment the damping assembly is arranged so as to axially overlap with the tensioning roller. This results in a particularly short length of the entire device.

In the region adjoining the bearing eye of the tensioning arm, it is possible to arrange on the housing a fixing flange which can serve as a threadable flange and, as such, is required as the only fixing element in addition to matching threading means for a unit.

According to a second advantageous embodiment, the damping assembly comprises a slotted friction sleeve. By means of an inner cylindrical face, the sleeve is positioned on an outer cylindrical face of a bearing eye connected to the tensioning arm and which slides on the cylindrical face if a relative movement occurs between the tensioning arm and the housing. This measure allows the damping assembly to be arranged on a diameter which has been increased again. The bearing eye can be cranked relative to the tensioning arm. According to an advantageous embodiment, it is proposed in this case, too, that the friction sleeve is surrounded by a slotted spring sleeve with radial pretension. In this embodiment, too, the friction sleeve and the spring sleeve can be form-fittingly and positively connected to one another in the circumferential direction. The spring sleeve can comprise a bracket which is radially bent open for being fixed in a rotationally fixed way in a component which can be connected to the housing. As the friction assembly is now positioned on the sleeve, it has to be fixed in the direction of rotation relative to a component to which the housing will be connected in the final analysis. For example, a unit or a carrier for the unit or carrier fixed on the unit which is enclosed in the belt drive for which the belt tensioning device is provided.

In the embodiment mentioned here, the damping assembly can be axially offset relative to the tensioning arm.

In this case, too, a fixing flange can be arranged so as to adjoin the sleeve of the tensioning arm. The fixing flange is provided in the form of a supporting flange which can cooperate with a tensioning sleeve and can be positioned on the end of the housing and axially tightened.

In all the above-mentioned embodiments, the torsion spring is preferably provided in the form of a bundle of spring bars which, by means of their ends, are form-fittingly inserted into bushes which, in turn, are either directly or indirectly connected to the housing on the one hand and to the tensioning arm on the other hand.

### BRIEF DESCRIPTION OF THE DRAWINGS

Preferred embodiments of the invention are illustrated in the drawings and will be described below.

FIG. 1 illustrates an inventive belt tensioning device in a first embodiment in a longitudinal section.

FIG. 2 illustrates a device according to FIG. 1 in a cross-section B-B.

FIG. 3 illustrates a device according to FIG. 1 in a cross-section C-C.

FIG. 4 illustrates an inventive belt tensioning device in a second embodiment in a longitudinal section.

FIG. 5 illustrates a device according to FIG. 4 in a cross-section B-B.

FIG. 6 illustrates a device according to FIG. 4 in a cross-section C-C.

FIG. 7 illustrates an inventive belt tensioning device in a third embodiment in a longitudinal section.

FIG. 8 illustrates a device according to FIG. 7 in a cross-section.

FIG. 9 illustrates a device according to FIG. 8 with supporting means.

### DETAILED DESCRIPTION OF THE INVENTION

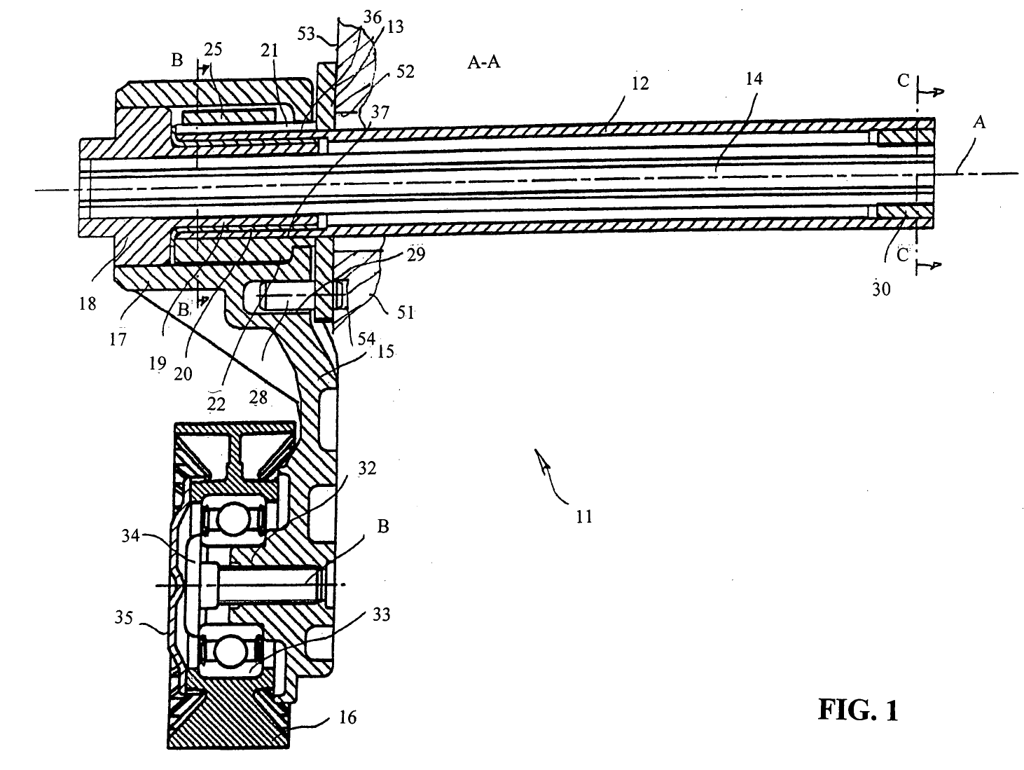

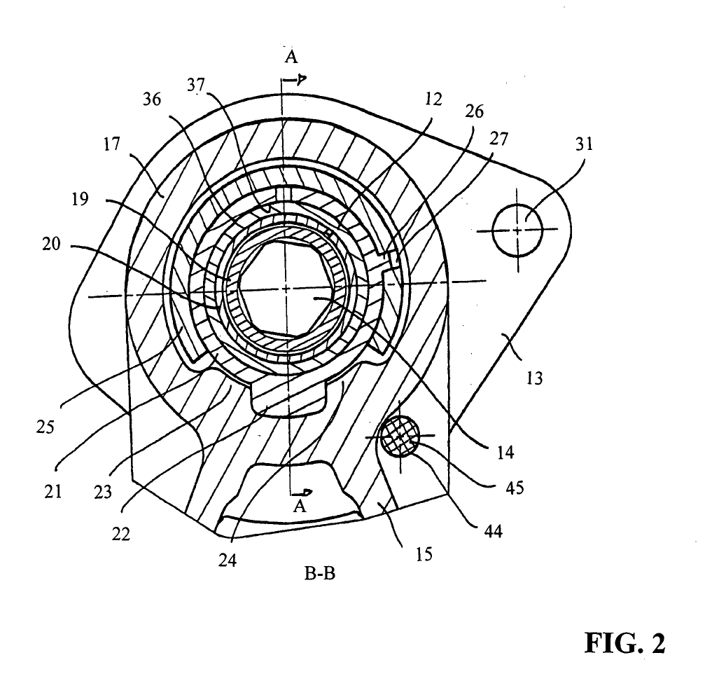

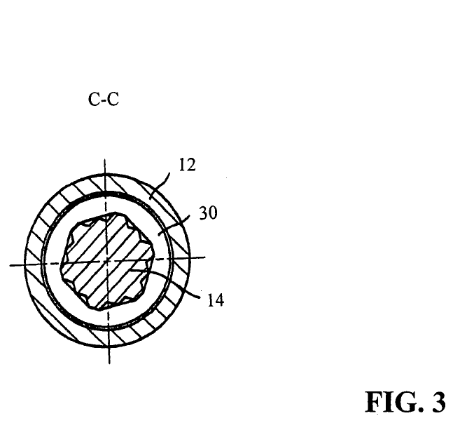

FIGS. 1 to 3 will be described jointly below. An inventive belt tensioning device 11 comprises a tubular housing 12 with a longitudinal axis A to the outside of which there is attached a fixing flange 13 in which there is positioned a torsion spring 14. A tensioning arm 15 oscillates around the longitudinal axis A and a tensioning roller 16 is rotatable at the free end of the tensioning arm around an axis of rotation B extending parallel relative to the longitudinal axis A. The tensioning arm 15 comprises a bearing eye 17 into which there is inserted a plug 18. The plug 18 comprises a sleeve projection 19 which engages the housing 12 and is rotatably supported therein a friction bearing bush 20. By means of a plug 30 firmly inserted into the housing, the torsion spring 14 is connected in a rotationally fixed way to one end of the housing 12. The other end of the torsion spring 14 is connected in a rotationally fixed way to the plug 18 and thus to the tensioning arm 15.

On the housing 12, inside the bearing eye 17, there is positioned a circumferentially slotted damping sleeve 21. By means of an outer rib 22 the bearing eye 17 is held in a rotationally fixed way between two rib holding devices 23, 24 in the bearing eye 17. The friction sleeve 21 is surrounded by a spring sleeve 25 which is also circumferentially slotted and which is radially pretensioned relative to the friction sleeve 21. By means of an inwardly directed radial pretension, the spring sleeve 25 holds the slotted friction sleeve 21 on the cylindrical housing 12 in position. The spring sleeve 25 is circumferentially form-fittingly and positively fixed relative to the friction sleeve 21 by a radial knob 26 which engages a suitably shaped hole 27 in the spring sleeve 25.

The fixing flange 13 can be seen to comprise an abutment pin 28 which engages a circumferentially extending oblong hole 29 in the tensioning arm 15. This structure delimits the relative pivot movement of the tensioning arm 15 relative to the fixing flange 13 and thus relative to the housing 12. Furthermore, in the fixing flange 13 there can be seen one of several fixing holes 31 for threading-on the fixing flange 13 by means of bolts to a unit.

Furthermore, at the outer end of the tensioning arm 15 there can be seen a journal attachment 32 on which there is supported the tensioning roller 16 by means of a deep groove ball bearing 33. The deep groove ball bearing 33 is secured by a bolt 34 on the journal attachment 32. For the purpose of sealing the deep groove ball bearing 33, a cover 35 is inserted into the tensioning roller 16. A securing pin 45 is inserted into a bore 44 in the tensioning arm 15 and passes through a corresponding bore in the fixing flange 13 and, for assembly purposes, holds the tensioning arm 15 in a greatly pretensioned position relative to the fixing flange.

As can be seen in detail in FIG. 1, the housing 12 (only partially illustrated) is inserted into a housing aperture 52 in the unit 51. The flange 13 rests against a flange face 53 in the unit 51, which flange face 53 points towards the end face of the unit 5 1. The entire belt drive is spread across to the end face. For preventing the flange from rotating, the pin 28 which passes through the flange 13 engages a countersunk portion 54 in the flange face 53. The flange 13 is clamped to the unit 51 by a bolt which cannot be seen in this sectional plane, which passes through the through-aperture 31 and is threaded into a threaded hole in the flange face 52.

The above-described design results in the following function of the belt tensioning device. The tensioning arm 15 with the bush 19 is pivotable relative to the housing 12 secured by the flange 13 around the longitudinal axis A. In the case of a pivot movement, the torsion spring 14 which, on the one hand, is secured in the plug 30 and thus in the housing 12 and, on the other hand, in the bush 19. Thus the tensioning arm 15 will be twisted against elastic returning forces. In the mounted condition, it is possible for the torsion spring 14 to be held in a greatly pretensioned twisted position. Each pivot movement of the tension arm 15 relative to the housing 12 generates a friction on the friction sleeve 21 which is tensioned radially inwardly by the flat spring 25 relative to the housing 12 in the friction face pair 36, 37 so that the oscillating movement of the tension arm is dampened. As can be seen in FIGS. 1, 2 and 3, the plugs 18, 30 each comprise a polygonal inner contour in which the torsion spring 14 is received in a form-fitting and positive way. The torsion spring 14 can be composed of a bundle of individual parallel spring bars which are not shown.

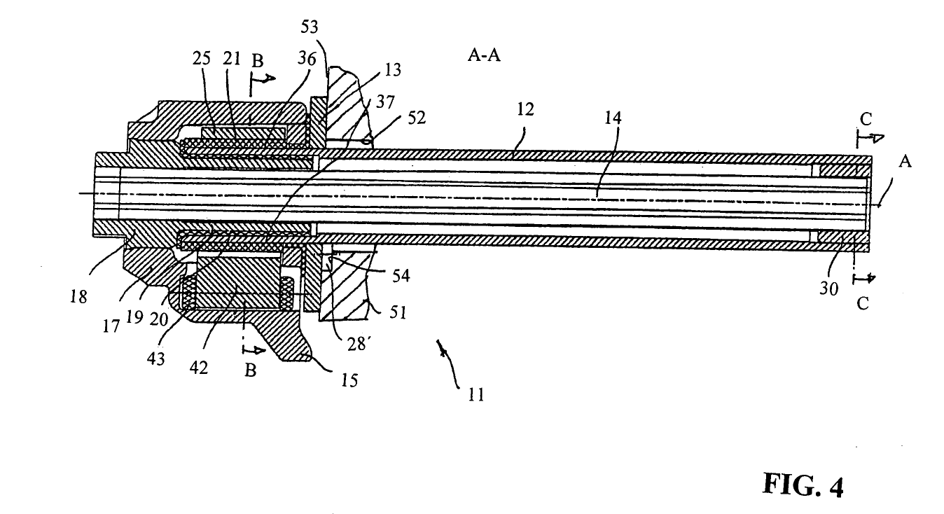

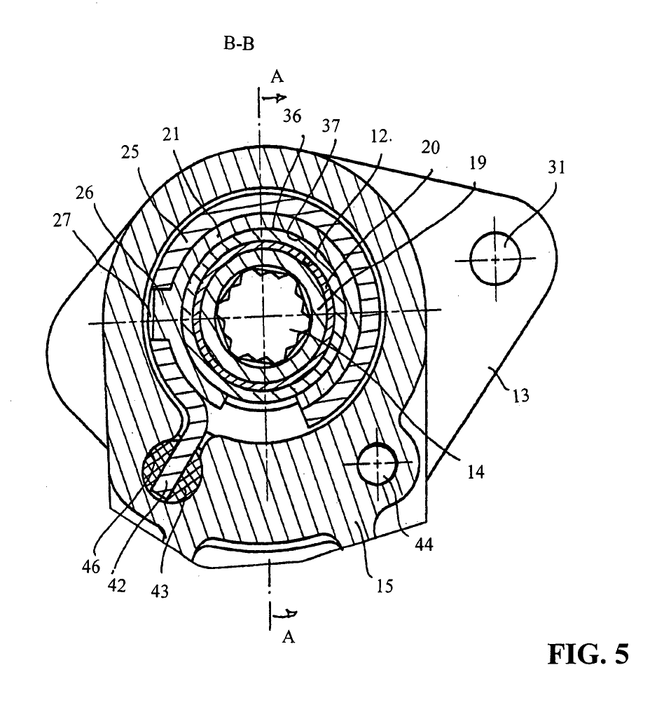

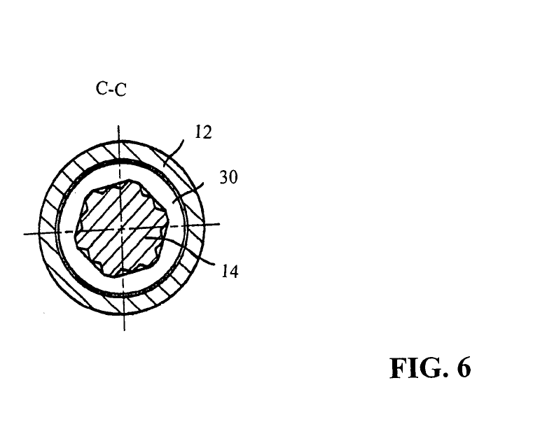

FIGS. 4 to 6 will be described jointly below. An inventive belt tensioning device 11 comprises a tubular housing 12 with a longitudinal axis A to the outside of which there is attached a fixing flange 13′ and in which there is positioned a torsion spring 14. A tensioning arm 15 oscillates around the longitudinal axis A. A tensioning roller is rotatable at the free end of the tensioning arm around an axis of rotation extending parallel relative to the longitudinal axis A. In FIGS. 4 and 5, the tensioning arm 15 is shown in a broken-off condition. It can be designed analogously to the tensioning arm illustrated in FIG. 1. The tensioning arm 15 comprises a bearing eye 17 into which there is inserted a plug 18. The plug 18 comprises a sleeve projection 19 which engages the housing 12 and is rotatably supported therein by means of a friction bearing bush 20. A plug 30 firmly inserted into the housing connects the torsion spring 14 is connected in a rotationally fixed way to one end of the housing 12. The other end of the torsion spring 14 is connected in a rotationally fixed way to the plug 18 and thus to tensioning arm 15.

On the housing 12, inside the bearing eye 17, there is positioned a circumferentially slotted damping sleeve 21. The friction sleeve 21 is surrounded by a spring sleeve 25 which is also circumferentially slotted and which is radially pretensioned relative to the friction sleeve 21 and thus, via an inwardly directed radial pretension, holds the slotted friction sleeve on the cylindrical housing 12 in position. The spring sleeve 25 is circumferentially form-fittingly and positively secured relative to the tensioning arm 15 by means of a radially outwardly bent bracket 42 which engages a pocket 46 in the tensioning arm 15, with a rubber-elastic damping element 43 being inserted between the two. The damping sleeve 21 is held in a rotationally fixed way in the spring sleeve 25, by a radial knob 26 which engages a correspondingly shaped hole 27 in the spring sleeve 25. In the fixing flange 13 there can be seen one of several fixing holes 31 for threading the fixing flange 13 by means of bolts on to a unit. Furthermore, in the fixing flange there is provided a bore 44 for receiving a securing pin for assembly purposes whose function has already been described in connection with the first embodiment.

As can be seen in FIG. 4, the housing 12 (illustrated only partially) has been inserted into a housing aperture 52 of a unit 51. The flange 13 rests against a flange face 53 of the unit 51 which surrounds the housing aperture 52. To prevent the flange 13 from rotating, a pin 28′ attached to the flange 13 engages a countersunk portion 54′ in the flange face 53 of the unit 51. The belt tensioning device is clamped to the unit 51 by means of a bolt (not shown in the section) which passes through the bolt hole 31 in the flange 13.

The above-described design results in the following function of the belt tensioning device. The tensioning arm 15 with the bush 19 is pivotable around the longitudinal axis A relative to the housing 12 secured by the flange 13. In the case of a pivot movement, the torsion spring 14 which, on the one hand, is secured in the plug 30 and thus in the housing 12 and, on the other hand, in the bush 19 and thus in the tensioning arm 15 is twisted against elastic returning forces. In the mounted condition, it is possible for the torsion spring 14 to be held in a greatly pretensioned twisted position. Each pivot movement of the tension arm 15 relative to the housing 12 generates a friction on the friction sleeve 21 which is radially pretensioned by the flat spring 25 relative to the housing 12 in the friction face pair 36, 37, so that the oscillating movement of the tension arm is dampened.

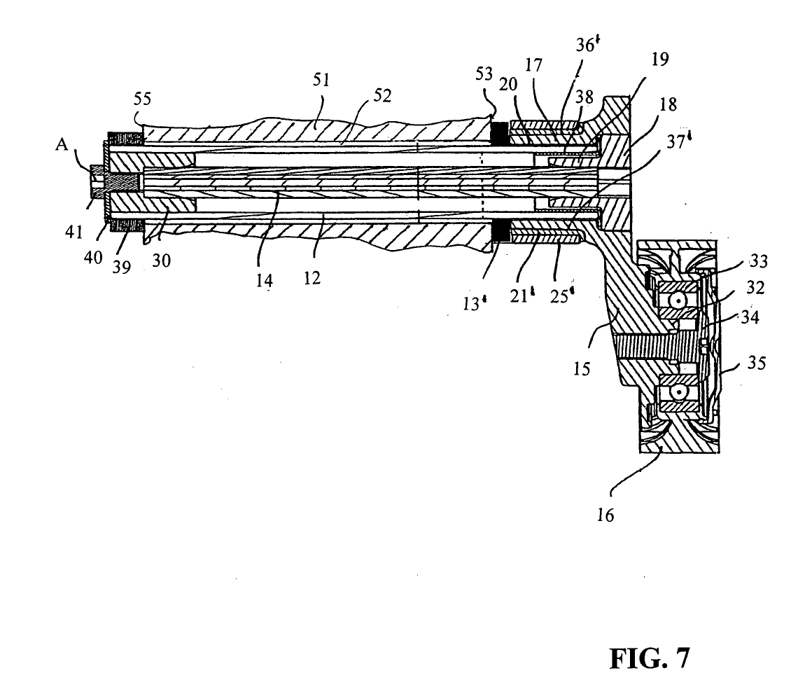

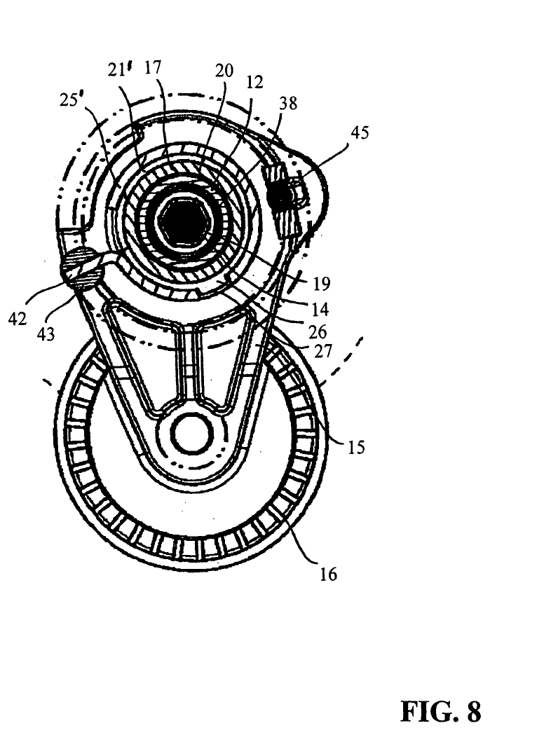

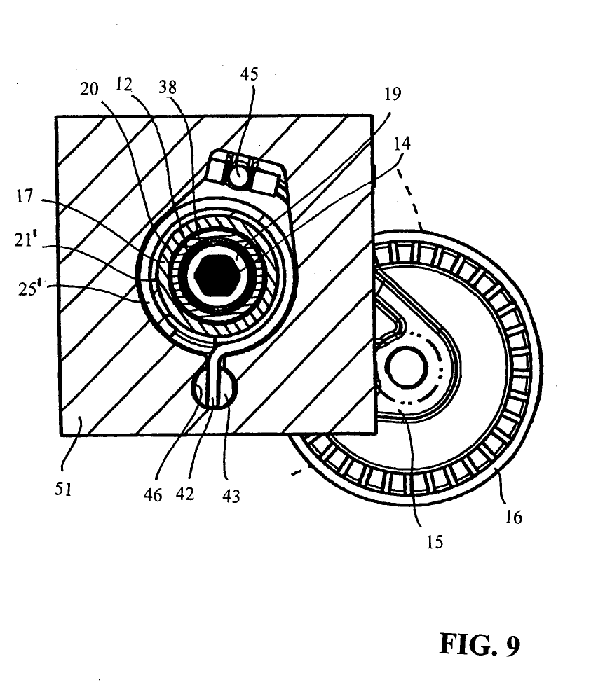

FIGS. 7 to 9 will be described jointly below. An inventive belt tensioning device 11 comprises a tubular housing 12 with a longitudinal axis A to the outside of which there is attached a fixing flange 13′ and in which there is positioned a torsion spring 14. A tensioning arm 15 oscillates around the longitudinal axis A. A tensioning roller 16 is rotatable at the free end of the tensioning arm around an axis of rotation B extending parallel relative to the longitudinal axis A. The tensioning arm 15 comprises a bearing eye 17 into which there is inserted a plug 18. The bearing eye 17′ is directly rotatably supported on the housing 12 by a friction bearing bush 20′. The plug 18 comprises a sleeve projection 19 which engages the housing 12 and is sealed relative thereto by a sealing sleeve 38. A plug 30 firmly is inserted into the housing and the torsion spring 14 is connected in a rotationally fixed way to one end of the housing 12. The other end of the torsion spring 14 is connected in a rotationally fixed way to the sleeve projection 39 of the plug 18 and thus to the tensioning arm 15. On the bearing eye 17′, there is positioned a circumferentially slotted damping sleeve 21. The friction sleeve 21 is surrounded by a spring sleeve 25′ which is also circumferentially slotted and which is radially pretensioned relative to the friction sleeve 21′. The radial pretension holds the slotted friction sleeve on the bearing eye 17′ in position. The spring sleeve 25′ is circumferentially form-fittingly secured relative to the friction sleeve 21′. A radial knob 26 engages a correspondingly shaped hole 27 in the flat spring 25′.

The fixing flange 13′ is a supporting flange and comprises only anti-rotation means relative to a supporting face of a unit or of an assembly to be fixed on. At the free end of the housing, there is provided an axial tensioning sleeve 39 which can be tensioned by means of a disc 40 and a bolt 41 threaded into the sleeve 21 in such a way that the housing 12 can be clamped into a unit or into an assembly to be fixed on, into which it has been inserted. A bracket 42 at the spring sleeve 25′ which is-radially bent has to be secured in a pocket 46 of the fixing housing, with a rubber-elastic damping element 43 being inserted between the two. Furthermore, at the outer end of the tensioning arm 15 there is provided a journal attachment 32 on which there is supported the tensioning roller 16 by means of a deep groove ball bearing 33, with the bearing being secured by a bolt 34 on the journal attachment 32. For sealing the deep groove ball bearing 33, a cover 35 has been inserted into the tensioning roller 16.

As can be seen in FIG. 7, the housing tube 12 has been inserted through a housing bore 52 of the unit 51 shown in a broken-off condition. The flange 13′ is supported on a flange face 53 and the tensioning bolt 39 is supported on a flange face 55 extending in the opposite direction. The belt tensioning device is clamped into the unit 51, with the mounting procedure taking place from the end face of the unit 51 across which end face the belt drive extends and which is defined by the position of the flange face 53.

The above-described design results in the following function of the belt tensioning device. The tensioning arm 15 with the bush 19 is pivotable around the longitudinal axis A relative to the housing 12 secured by the flange 13 and the sleeve 39. In the case of a pivot movement, the torsion spring 14 which, on the one hand, is secured in the plug 30 and thus in the housing 12 and, on the other hand, in the plug 18 and thus in the tensioning arm 15 is twisted against elastic returning forces. In the mounted condition, it is possible for the torsion spring 14 to be held in an already greatly pretensioned twisted position. Each pivot movement of the tension arm 15 relative to the housing 12 generates a friction on the fixed friction sleeve 21 which is radially pretensioned by the flat spring 25 relative to the bearing eye 17′ which is moved together with the tensioning arm 15, so that the oscillating movement of the tension arm is dampened.

I claim:

1. A belt tensioning device comprising a torsion spring assembly and a damping assembly with a housing with a longitudinal axis (A). A torsion spring is positioned in said housing so as to extend coaxially relative to said longitudinal axis (A) and wherein one of its ends is secured in said housing in a rotationally fixed way; a tensioning arm which is supported relative to said housing so as to be oscillatingly rotatable around said longitudinal axis (A) and which is connected to the other end of said torsion spring in a rotationally fixed way, and a tensioning roller which, at a free end of said tensioning arm, is supported so as to be rotatable around an axis of rotation (B) extending parallel relative to the longitudinal axis (A), wherein said damping assembly surrounds said housing coaxially relative to the longitudinal axis (A) and comprises cylindrical friction face pairs.

2. A device according to claim 1, wherein said damping assembly comprises a circumferentially slotted friction sleeve which, by means of an inner cylindrical face, is positioned on an outer cylindrical face of the housing and which slides on the cylindrical face in the case of a relative movement of said tensioning arm relative to said housing.

3. A device according to claim 2, wherein said friction sleeve is held in a form-fitting and positive way in the direction of rotation in said tensioning arm and is surrounded by a slotted spring sleeve with a radial pretension, wherein the form-fitting means of said friction sleeve pass through the slot of a spring sleeve.

4. A device according to any one of claims 2 or 3, wherein said friction sleeve is form-fittingly and positively held by means of an outer formed projection, more particularly a rib in a bearing eye of said tensioning arm.

5. A device according to claim 2, wherein said friction sleeve is surrounded by a slotted spring sleeve with radial pretension, wherein said spring sleeve is form-fittingly and positively held in the direction of rotation in said tensioning arm.

6. A device according to claim 5, wherein said spring sleeve comprises an outwardly bent bracket which is secured in a pocket in said tensioning arm.

7. A device according to claim 6, wherein between said bracket and said pocket there are inserted elastic damping means.

8. A device according to any one of claims 2, 3 5, 6 or 7, wherein said friction sleeve and the spring sleeve are circumferentially form-fittingly and positively connected to one another, more particularly by combined pin and bore engaging means.

9. A device according to any one of claims 2, 3, 5, 6 or 7, wherein said damping assembly is arranged so as to radially overlap with a tensioning roller.

10. A device according to any one of claims 2, 3, 5, 6 or 7, wherein at the region adjoining a bearing eye of said tensioning arm, a fixing flange is firmly arranged on said housing, more particularly in the form of an annular flange aligned normally relative to said longitudinal axis (A).

11. A device according to claim 7, wherein a fixing flange is provided in the form of a threadable flange.

12. A device according to claim 1, wherein said damping assembly comprises a slotted friction sleeve which, by means of an inner cylindrical face is positioned on an outer cylindrical face of a bearing eye connected to said tensioning arm and which slides on said cylindrical face if a relative movement occurs between said tensioning arm and the housing.

13. A device according to claim 12, wherein said friction sleeve is enclosed by a slotted spring sleeve with radial pretension.

14. A device according to any one of claims 12 or 13, wherein said friction sleeve and said spring sleeve are circumferentially form-fittingly and positively connected to one another, more particularly via combined pin and bore engaging means.

15. A device according to claim 13, wherein said spring sleeve comprises a bracket for being secured in a rotationally fixed way in a component which can be connected to the housing.

16. A device according to claim 15, wherein said damping assembly is axially offset relative to said tensioning roller.

17. A device according to claim 16, wherein in the region axially adjoining said bearing eye of said tensioning arm, there is firmly arranged a fixing flange on said housing.

18. A device according to claim 17, wherein said fixing flange is provided in the form of a contact and support flange with anti-rotation means and cooperates with a supporting sleeve which can be threaded to the free end of said housing.
